(19) United States
(12) Patent Application Publication
(10) Pub. No.: US 2016/0106267 A1
(43) Pub. Date: Apr. 21, 2016

(54) SAFETY POCKET FOR COMMERCIAL KITCHEN UTENSILS AND METHODS OF USING THE SAME

(71) Applicant: Luis Javier Cisneros, San Antonio, TX (US)

(72) Inventor: Luis Javier Cisneros, San Antonio, TX (US)

(21) Appl. No.: 14/884,719

(22) Filed: Oct. 15, 2015

Related U.S. Application Data
(60) Provisional application No. 62/064,448, filed on Oct. 15, 2014.

(51) Int. Cl. A47J 47/16

(52) U.S. Cl. CPC A47J 47/16

(57) ABSTRACT

A safety pocket device for attaching and storing kitchen utensils, commercial and noncommercial, and a method of using the same are disclosed herein. It is an object of the invention to store kitchen utensils in a safe and sanitary manner to prevent dangerous conditions that result from dripping fluids and foods. In an embodiment, the safety pocket device generally is comprised of a main body portion having an opening for receiving kitchen utensils such as tongs and a fluid capture portion. The fluid capture portion may be permanently fixed to said main body portion, able to be opened, or may be detachable from said main body portion. In another embodiment, the safety pocket device is further comprised of an attachment portion. The attachment portion provides the means for attaching the safety pocket device to a user or other object such as a kitchen counter.

### CROSS-REFERENCE TO RELATED APPLICATIONS

This application claims the benefit under Title 35 United States Code §119(e) of U.S. Provisional Patent Application Ser. No. 62/064,448; Filed: Oct. 15, 2014, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention relates generally to a device and method of use for the storing of utensils. More specifically, the present invention relates to a device and method of use for attaching and storing kitchen utensils, such as commercial and noncommercial kitchen utensils, in a safe and sanitary manner to prevent dangerous conditions that result from dripping fluids and foods.

### BACKGROUND OF THE INVENTION

Without limiting the scope of the disclosed device and method, the background is described in connection with a novel device and approach to store kitchen utensils.

The field's prior art fails to provide a quick, sanitary, and safe method for storing kitchen utensils while working in a kitchen or cooking in general. This is important to note as many kitchen workers will store utensils, such as but not limited to tongs, in their pant or apron pockets. As a result, drippings from the food and liquids that remains on the utensils drip into the pockets and leak onto floors. Over time, clothing can become unusable due to excessive amounts of food and liquids causing unsanitary conditions for storage and sharp utensils cutting through fabrics. Additionally, liquids, such as but not limited to grease, can leak onto kitchen floors creating unsafe working conditions. In addition, often times the utensils may be placed on top of counters or cooking areas, which produce the same issues mentioned.

In view of the foregoing, it is apparent that there exists a need in the art for a safety pocket device for kitchen utensils, which overcomes, mitigates, or solves the above problems in the art. It is the purpose of this invention to fulfill this and other needs in the art, which will become apparent to the skilled artisan once given the following disclosure.

### BRIEF SUMMARY OF THE INVENTION

The present invention, therefore, provides a device and method of use for storing kitchen utensils. That is, a device that is capable of storing a kitchen utensil, such as tongs, in a safe and sanitary manner by attaching to a user of the device or an object such as a kitchen counter.

In an embodiment, the safety pocket device generally is comprised of a main body portion having an opening for receiving kitchen utensils such as tongs and a fluid capture portion. The fluid capture portion may be permanently fixed to said main body portion, able to be opened, or may be detachable from said main body portion. In an embodiment, the fluid capture portion is positioned at the bottom of the main body portion and captures any food drippings, such as grease, to prevent it from spreading onto clothing or falling onto the floor. As a result, the kitchen worker is able to store the utensil in a dedicated device without the utensil making contact with any other item.

In another embodiment, the safety pocket device is further comprised of an attachment portion. The attachment portion provides the means for attaching the safety pocket device to a user or other object such as a kitchen counter. In an embodiment, this may be a clip, a magnet, or a combination thereof.

In summary, the present invention discloses a device and method of use for storing kitchen utensils. More specifically, the present invention relates to a device and method of use for attaching and storing kitchen utensils, such as commercial and noncommercial kitchen utensils, in a safe and sanitary manner to prevent dangerous conditions that result from dripping fluids and foods.

### BRIEF DESCRIPTION OF THE SEVERAL VIEWS OF THE DRAWINGS

The accompanying drawings, which are incorporated in and form a part of the specification, illustrate a preferred embodiment of the present invention, and together with the description, serve to explain the principles of the invention. It is to be expressly understood that the drawings are for the purpose of illustration and description only and are not intended as a definition of the limits of the invention. In the drawings:

FIG. 1 is a back perspective view of one embodiment of the safety pocket device in accordance with the teachings of the present disclosure;

FIG. 2 is a front view of the safety pocket device in accordance with the teachings of the present disclosure;

FIG. 3 is a back view of one embodiment of the safety pocket device in accordance with the teachings of the present disclosure;

FIG. 4 is a right view of one embodiment of the safety pocket device in accordance with the teachings of the present disclosure;

FIG. 5 is a left view of one embodiment of the safety pocket device in accordance with the teachings of the present disclosure;

FIG. 6 is a top view of one embodiment of the safety pocket device in accordance with the teachings of the present disclosure;

FIG. 7 is a bottom view of one embodiment of the safety pocket device in accordance with the teachings of the present disclosure;

FIG. 8 is an environmental view of one embodiment of the safety pocket device illustrating the device attached to the belt of a user in accordance with the teachings of the present disclosure.

### DETAILED DESCRIPTION OF THE INVENTION

Disclosed herein is an improved device and method of use for a device and method of use for attaching and storing kitchen utensils, such as commercial and noncommercial kitchen utensils, in a safe and sanitary manner to prevent dangerous conditions that result from dripping fluids and foods. The numerous innovative teachings of the present invention will be described with particular reference to several embodiments (by way of example, and not of limitation).

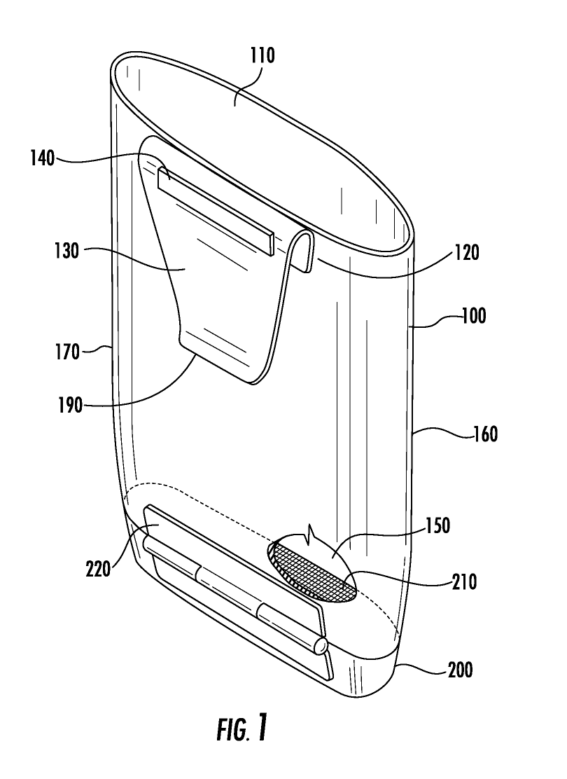

Reference is first made to FIG. 1, a back perspective view of one embodiment of the safety pocket device in accordance with the teachings of the present disclosure. In this illustration, a layout of the components or portions is shown.

In an embodiment, the safety pocket device generally is comprised of a main body portion 100 and a fluid capture portion 200. Said main body portion 100 is closed on all sides, except for at least one opening 110, and forming a cavity or pocket for holding kitchen utensils. Said opening 110 is of sufficient size for receiving kitchen utensils such as tongs. In this illustration are shown the left side 160 and the right side 170 of the safety pocket device.

The fluid capture portion 200 may be permanently formed as part of said main body portion 100. In an embodiment, the fluid capture portion 200 is positioned at the bottom of the main body portion 100 and captures any food drippings, such as grease, to prevent it from spreading onto clothing or falling onto the floor. As a result, the kitchen worker is able to store the utensil in a dedicated device without the utensil making contact with any other item. The main body portion 100 and the fluid capture portion 200 may be separated by a boundary separation element or component which in embodiments may be for example but not a limitation, mesh or screen 210 preferably made out of a rigid material. The cutaway 150 provides a better view of the positioning and layout of this component. The mesh or screen component 210 prevents the kitchen utensil from sitting in the fluid or food drippings captured in the fluid capture portion 200 while allowing those fluids or food drippings to pass from the main body portion 100 to the fluid capture portion 200. When the safety pocket device is finished being used, the utensils are removed and rinsing out with soap and water can clean the safety pocket device. In an embodiment, the safety pocket device is made out of materials that allow it to be dishwasher safe. In yet another embodiment, the mesh or screen component 210 is a removable insert. In an embodiment, the fluid capture portion 200 is a removable portion to aid in the cleaning of the safety pocket device. That is, the fluid capture portion 200 may be detached and reattached as needed. This may be accomplished by having the fluid capture portion 200 fitted with clasps along the edges in contact with the main body portion 100. Another way to accomplish this is to have the fluid capture portion 200 sized to snap into the bottom of the main body portion 100. In yet another embodiment, the fluid capture portion 200 may be opened and closed through the utilization of a hinge 220 or similar structure to accomplish the same function.

In another embodiment, the safety pocket device is further comprised of an attachment portion 130. The attachment portion 130 provides the means for attaching the safety pocket device to a user or other object such as a kitchen counter. In an embodiment, this may be for example and not a limitation, a clip 130, a magnet 140, an adhesive, Velcro, or a combination thereof and may be located at various positions on the safety pocket device. In this illustration a combination of a clip 130 and a magnetic strip 140 is shown on the back side of the device. The clip 130 is used to attach the safety pocket device to the user's belt, pocket, or other area of the user by sliding that user object through the opening side 190 of the clip 130. The other end of the clip 130 is attached to the safety pocket device 120. The magnetic strip 140 may be utilized to attach the safety pocket device to a metallic surface such as a refrigerator or the side of a cooking apparatus. For example, if a cook is grilling, he or she may attach the safety pocket device to the side of the grill.

The safety pocket device in an embodiment is made out of a rigid material or combination of rigid materials such as but not limited to a polymer, rubber, or metal. In another embodiment, the safety pocket device may be made out of a flexible material such as but not limited to a polymer, rubber, and/or silicone. The materials utilized in the construction may also have thermal properties to allow the device to be heat resistant. That is the hot fluids and materials captured internally in the device will not easily have the heat passed to the outside of the device.

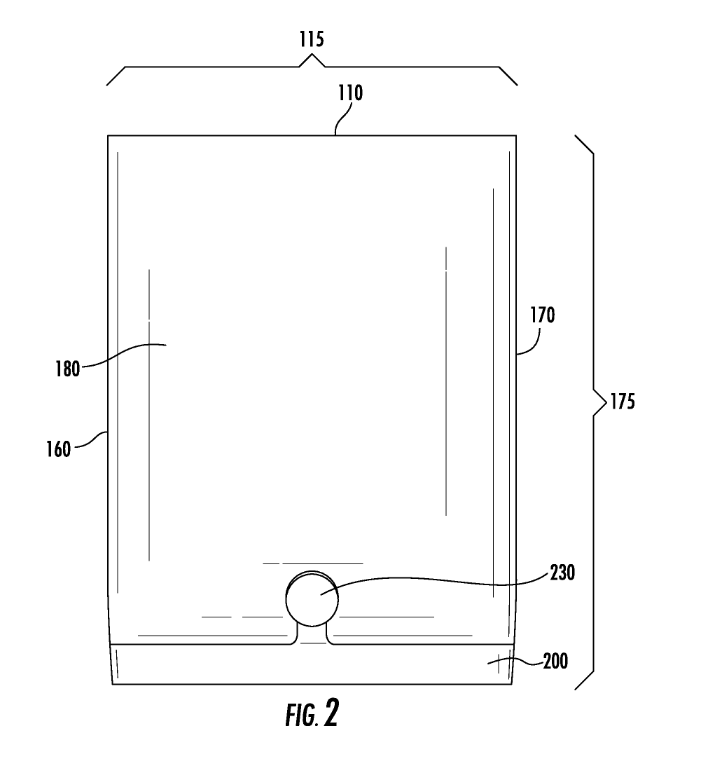

Reference is next made to FIG. 2, a front view of the safety pocket device in accordance with the teachings of the present disclosure. In this illustration is shown the front side of the pocket safety device 180 with a release tab 230 for opening or removing the fluid capture portion 200 from the front side 180 in an embodiment. The release tab 230 may also be other forms of releasably attaching the fluid capture portion 200 to the main body portion 100 such as clasps, hooks, and snaps. In an embodiment, the safety pocket device is sized so that the width 115, the height 175, and the depth 117 of the device allow it to also be inserted into a front or back pocket of a user. That is the safety pocket device is used while inserted into a user's pocket. In another embodiment, while the safety pocket device is being used in this manner, the clip 130 faces outward or away from the user and is attached to the pocket to assist in securing the device to the user's pocket. In another embodiment, the width 115 is 4.5 inches, the height 175 is six inches, and the depth 117 is one to three inches. In an embodiment the depth of the fluid capture portion 200 in the height direction is a half of an inch.

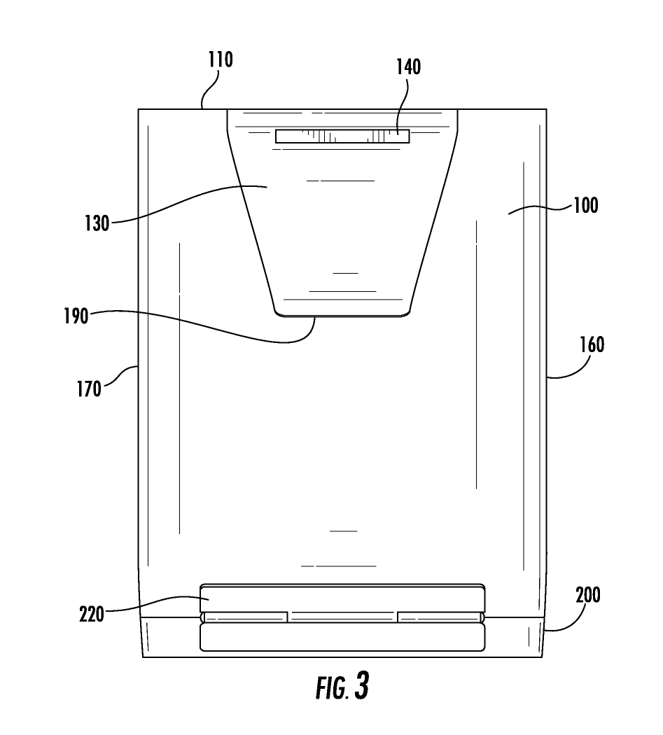

Reference is now made to FIG. 3, a back view of one embodiment of the safety pocket device in accordance with the teachings of the present disclosure. This illustration provides another view of the back structures and layout of the device.

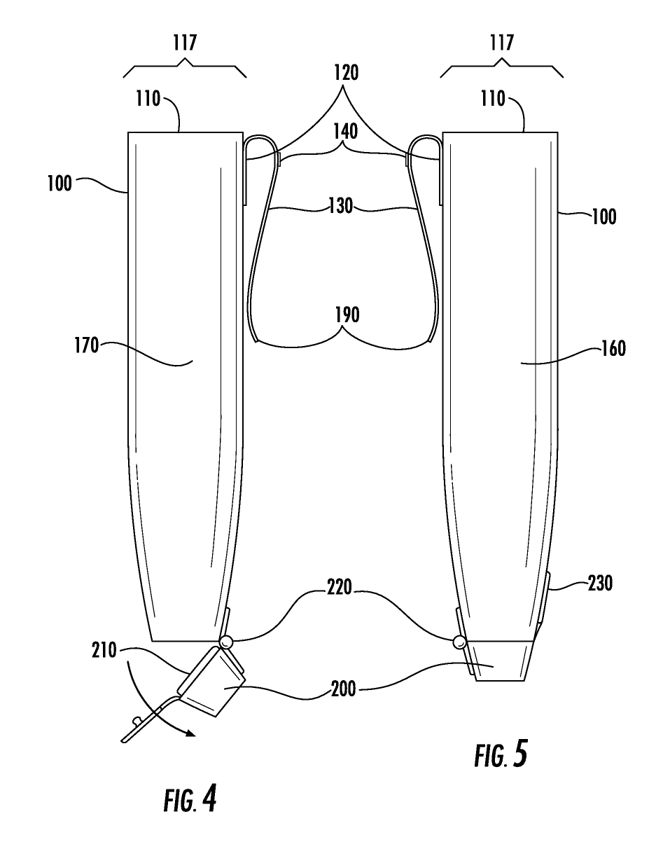

Reference is next made to FIG. 4, a right view of one embodiment of the safety pocket device in accordance with the teachings of the present disclosure. In this illustration is shown the width 117 of the safety pocket device as well as the fluid capture portion 200 being opened by the release tab 230 and the mesh or screen component 210 remaining with the fluid capture portion 200. In another embodiment, the mesh or screen component 210 remains at the bottom of the main body portion 100 as to prevent the utensils from sliding through and out of the bottom of the main body portion 100.

Reference is now made to FIG. 5, a left view of one embodiment of the safety pocket device in accordance with the teachings of the present disclosure. In this illustration is shown the fluid capture portion 200 in the closed or attached position.

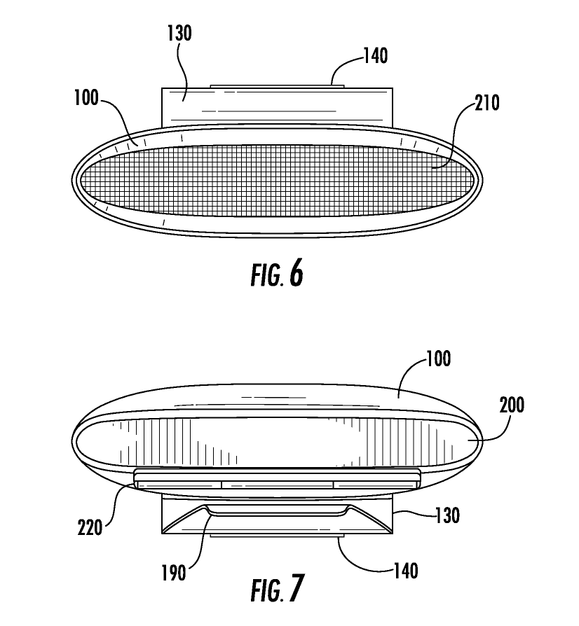

Reference is next made to FIG. 6, a top view of one embodiment of the safety pocket device in accordance with the teachings of the present disclosure. Illustrated here is a view looking down the opening 110 of the main body portion 100. In this view we have a direct look at the mesh or screen component structure 210 which forms the bottom of the main body portion 100.

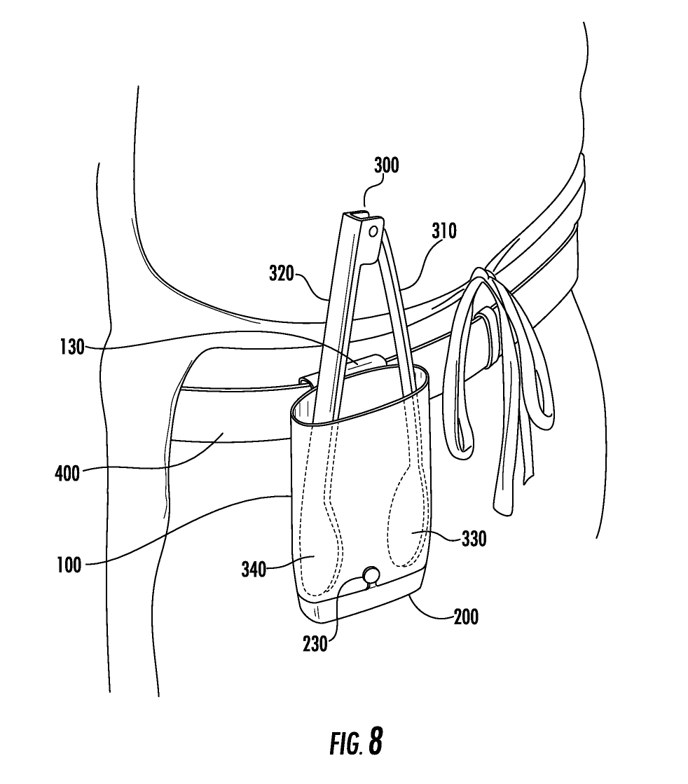

Reference is now made to FIG. 7, a bottom view of one embodiment of the safety pocket device in accordance with the teachings of the present disclosure. Illustrated here are the structures described herein from the bottom of the safety pocket device.

Lastly, reference is made to FIG. 8, an environmental view of one embodiment of the safety pocket device illustrating the device attached to the belt of a user in accordance with the teachings of the present disclosure. Illustrated in this view is the safety pocket device attached to the user's belt 400 through the use of the clip 130. The user is depicted wearing an apron. A tong 300 kitchen utensil is also depicted with both arms 310, 320 inserted into the opening 110 of the main body portion 100. The tong ends 330, 340 are stopped by the mesh or screen component structure 210 so that the tong 300 does not enter the fluid capture portion 200.

The disclosed device and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Alternative applications for this invention include using this device and method of use for other types of objects that may be exposed to liquids such as lab equipment and automotive tools. Consequently, any embodiments comprising a one piece or multi piece device having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and method of use described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The device and/or methods disclosed and claimed herein can be made and executed without undue experimentation in light of the present disclosure. While the device and methods of this invention have been described in terms of preferred embodiments, it will be apparent to those skilled in the art that variations may be applied to the device and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A safety pocket device for kitchen utensils comprising:
a main body portion; and
a fluid capture portion;
wherein said fluid capture portion is attached to said main body portion;
and wherein said main body portion is configured to form at least one opening for receiving a kitchen utensil.

2. The safety pocket device of claim 1, wherein said main body portion has at least one said opening on the top side.

3. The safety pocket device of claim 1, wherein said main body portion has at least one said opening on the front side.

4. The safety pocket device of claim 1, wherein said main body portion has at least one said opening on the back side.

5. The safety pocket device of claim 1, wherein said fluid capture portion is integrally formed with said main body portion.

6. The safety pocket device of claim 1, wherein said fluid capture portion is configured to be opened.

7. The safety pocket device of claim 1, wherein said fluid capture portion is configured to be releasably attached to said main body portion.

8. The safety pocket device of claim 6, wherein said fluid capture portion is configured to be releasably attached to said main body portion.

9. The safety pocket device of claim 1, wherein said fluid capture portion is positioned below said main body portion.

10. The safety pocket device of claim 6, wherein said fluid capture portion is positioned below said main body portion.

11. The safety pocket device of claim 8, wherein said fluid capture portion is positioned below said main body portion.

12. The safety pocket device of claim 1, further comprised of a boundary separation component positioned substantially between said main body portion and said fluid capture portion.

13. The safety pocket device of claim 5, further comprised of a boundary separation component positioned substantially between said main body portion and said fluid capture portion.

14. The safety pocket device of claim 8, further comprised of a boundary separation component positioned substantially between said main body portion and said fluid capture portion.

15. The safety pocket device of claim 11, further comprised of a boundary separation component positioned substantially between said main body portion and said fluid capture portion.

16. The safety pocket device of claim 6, wherein said boundary separation component is mesh.

17. The safety pocket device of claim 6, wherein said boundary separation component is a screen.

18. The safety pocket device of claim 6, wherein said boundary separation component is removable.

19. The safety pocket device of claim 1, further comprising an attachment portion.

20. A safety pocket device for kitchen utensils comprising:
a main body portion;
a fluid capture portion;
a boundary separation component; and
an attachment portion;
wherein said fluid capture portion is attached to the bottom side of said main body portion;
and wherein said main body portion is configured to form at least one opening for receiving a kitchen utensil;
and wherein said main body portion has at least one said opening on the top side;
and wherein said fluid capture portion is configured to be opened;
and wherein said boundary separation component is positioned substantially between said main body portion and said fluid capture portion;
and wherein said boundary separation component is removable.
